(19) United States
(12) Patent Application Publication
(10) Pub. No.: US 2012/0013655 A1
(43) Pub. Date: Jan. 19, 2012

(54) METHOD FOR MODULATING DISPLAY DATA OF FLAT DISPLAY AND FLAT DISPLAY USING THE SAME

(75) Inventors: Fu-Chuan TSAI, Hsin-Chu (TW); Yu-Chun TSAI, Hsin-Chu (TW); Li-Ru LYU, Hsin-Chu (TW)

(73) Assignee: AU OPTRONICS CORP., HSINCHU (TW)

(21) Appl. No.: 13/090,390

(22) Filed: Apr. 20, 2011

(30) Foreign Application Priority Data
Jul. 13, 2010 (TW) 099122973

(51) Int. Cl. G09G 5/02

(52) U.S. Cl. 345/691

(57) ABSTRACT

A method for modulating display data of a flat display, comprises receiving a display datum with a digital count between a maximum digital count and a minimum digital count; modulating the display datum to correspondingly generate a modulated display datum, wherein the modulated display datum has a digital count same as that of the corresponding display datum when the digital count of the corresponding display datum is the same as the maximum digital count, and the modulated display datum has the digital count less than that of the corresponding display datum when the digital count of the corresponding display datum is less than the maximum digital count, wherein at least one modulated display datum has the digital count less than that of the corresponding display datum; and outputting the modulated display datum.

### FIELD OF THE INVENTION

The present invention relates to the black-compensation field of the display technology, and more particularly to a method for modulating display data of a flat display with a black-compensation and a flat display using the same.

### BACKGROUND OF THE INVENTION

With the rapid development of the science and technology, the flat display (such as the liquid crystal display) has many advantages, such as high image quality, little size, light weight and wide application-range, etc., thus it is widely applied into various consuming electronic products, such as mobile phone, notebook computer, desktop display and television, etc., and has gradually substituted the conventional cathode ray tube (CRT) display to be a main trend of the display.

The flat display generally comprises a plurality of pixels. When the flat display operates, each of the pixels of the flat display displays a received display datum respectively for displaying a corresponding image on the flat display. For enhancing the display effect of the flat display, it generally employs various methods for modulating a display datum of each of the pixels to enhance the display effect of the flat display. Therein, a black-compensation technology is specifically used to enhance the display effect of a dark image.

Refer to FIG. 1, which is a schematic view of a conventional method for modulating display data of a flat display. The following will employ a method for modulating a display datum of a pixel as an example for describing the conventional method. As shown in FIG. 1, the display datum has a digital count between a maximum digital count of 255 and a minimum digital count of 0. The conventional method is shifting the display datum in parallel towards a negative direction for shadow enhancement. That is, the conventional method is subtracting digital count of the display datum by a predetermined value, such as a predetermined digital count of 8, when the digital count of the display datum is larger than the predetermined digital count of 8; and altering the digital count of the display datum to the minimum digital count of 0 when the digital count of the display datum is not larger than the predetermined value with the digital count of 8, to reduce the display datum which should be displayed by the pixel, for enhancing the contrast display effect of the dark image which is displayed on the flat display.

However, when the digital count of the display datum is the maximum digital count of 255, the conventional method still subtracts the digital count of the display datum by the predetermined digital count of 8. Thus, the conventional method not only enhances the display effect of the flat display in dark, but also reduces the display effect of the flat display in bright. Therefore, the image displayed on the flat display darkens.

### SUMMARY OF THE INVENTION

Therefore, the object of the present invention is to provide a method for modulating display data of a flat display, which can enhance the display effect of the flat display in dark and does not influence the display effect of the flat display in bright.

The object of the present invention is also to provide a flat display, which can enhance the display effect of the flat display in dark and does not influence the display effect of the flat display in bright.

The present invention provides a method for modulating display data of a flat display, comprises receiving a display datum with a digital count between a maximum digital count and a minimum digital count; modulating the display datum to generate a modulated display datum, wherein the modulated display datum has a digital count same as that of the display datum when the digital count of the display datum is the same as the maximum digital count, and the modulated display datum has the digital count no more than that of the display datum when the digital count of the display datum is less than the maximum digital count, wherein at least one modulated display datum has the digital count less than that of the corresponding display datum; and outputting the modulated display datum.

The present invention also provides a flat display, which comprises an input unit, a modulating unit and an output unit. The input unit is configured for receiving a display datum with a digital count between a maximum digital count and a minimum digital count. The modulating unit is electrically coupled to the input unit for receiving the display datum from the input unit and modulating the display datum to generate a modulated display datum, wherein the modulated display datum has a digital count same as that of the display datum when the digital count of the display datum is the same as the maximum digital count, and the modulated display datum has the digital count no more than that of the display datum when the digital count of the display datum is less than the maximum digital count, wherein at least one modulated display datum has the digital count less than that of the corresponding display datum. The output unit is electrically coupled to the modulating unit for receiving the modulated display datum generated by the modulating unit, and outputting the modulated display datum.

Preferably, the modulating unit reduces the display datum according to a linear modulating method to obtain a modulated result, regards a digital count of 0 as the digital count of the modulated display datum when the modulated result is smaller than 0, and regards the modulated result as the digital count of the modulated display datum when the modulated result is not smaller than 0.

Preferably, the minimum output is a digital count of 0, and the maximum output is a digital count of 255.

Preferably, the linear modulating method is modulating the display datum according to Output=Input+Offset*(255−Input)/255, Output is the modulated result, Input is the digital count of the display datum, and Offset is a predetermined value designated by a user.

The flat display and the method for modulating the display data of the present invention not only can enhance the display effect of the flat display in dark, but also can keep unchanging the maximum display datum in modulating. Therefore, it will not influence the display effect of the flat display in bright, and can enhance the contrast degree of the flat display.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of a conventional method for modulating display data of a flat display.

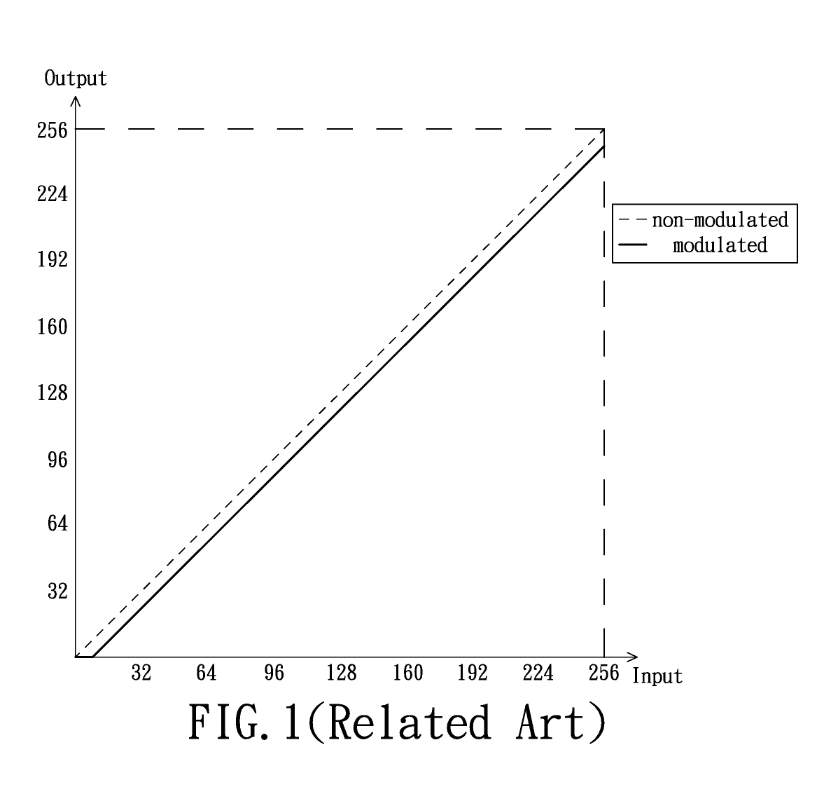

FIG. 2 is a schematic view of a flat display in accordance with an exemplary embodiment of the present invention.

FIG. 3 is a flow chart of a method for modulating display data of a flat display in accordance with an exemplary embodiment of the present invention.

FIG. 4 is a schematic view of modulating the display data in the method as shown in FIG. 3.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

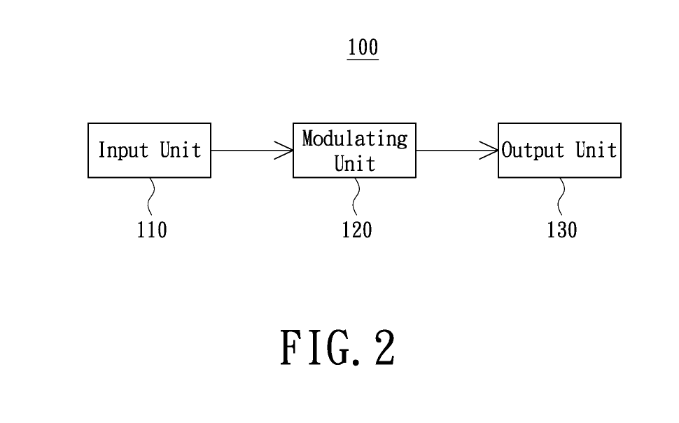

Refer to FIG. 2, which is a schematic view of a flat display in accordance with an exemplary embodiment of the present invention. As shown in FIG. 2, the flat display 100 comprises an input unit 110, a modulating unit 120 and an output unit 130. Therein, the input unit 110 is configured for receiving display data, the modulating unit 120 is electrically coupled to the input unit 110 for receiving the display data received by the input unit 110 and modulating the display data to generating modulated display data, and the output unit 130 is electrically coupled to the modulating unit 120 for receiving and outputting the modulated display data. The detailed method will be described in which the modulating unit 120 modulates the display data received by the input unit 110 to generate the modulated display data.

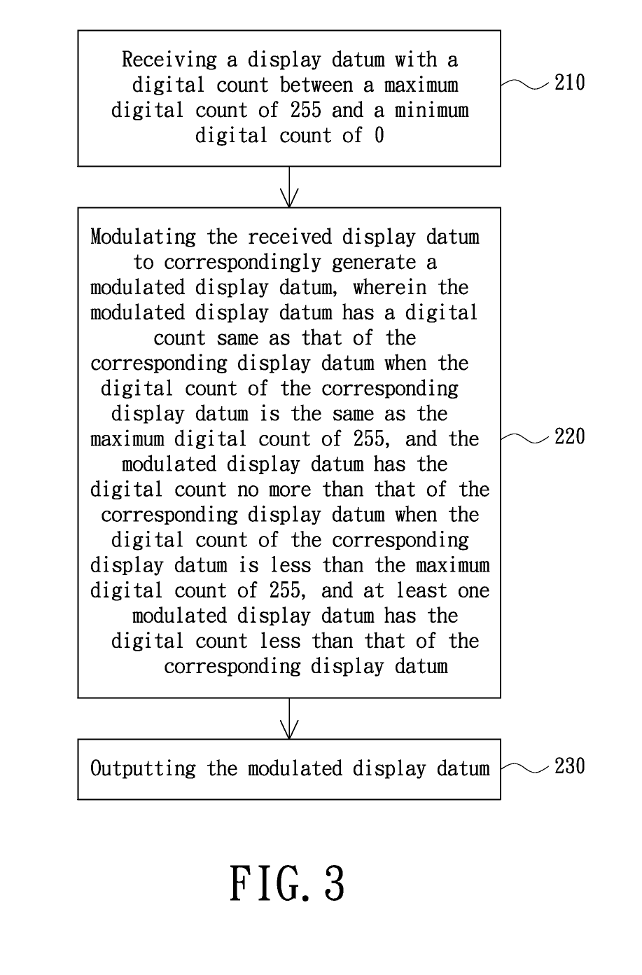

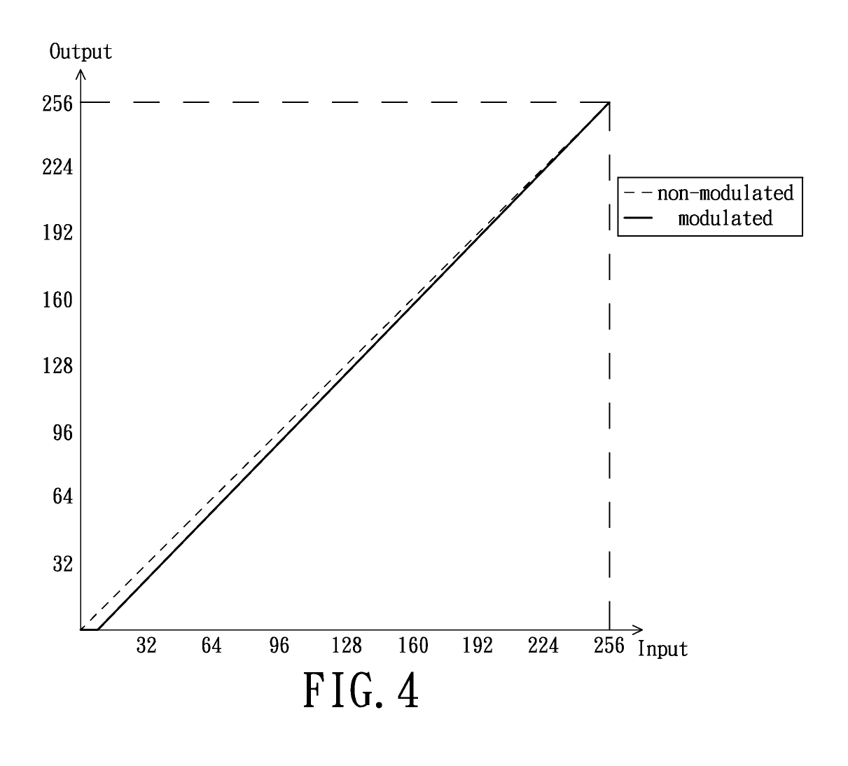

Refer to FIGS. 3-4, wherein FIG. 3 is a flow chart of a method for modulating display data of a flat display in accordance with an exemplary embodiment of the present invention, and FIG. 4 is a schematic view of modulating the display data in the method as shown in FIG. 3. The following will employ a display datum of a pixel as an example for describe the method for modulating the display datum of the present invention. As shown in FIGS. 3-4, the method of the exemplary embodiment comprises a step 210 of receiving a display datum with a digital count between a maximum digital count of 255 and a minimum digital count of 0; a step 220 of modulating the received display datum to correspondingly generate a modulated display datum, wherein the modulated display datum has a digital count same as that of the corresponding display datum when the digital count of the corresponding display datum is the same as the maximum digital count of 255, and the modulated display datum has the digital count no more than that of the corresponding display datum when the digital count of the corresponding display datum is less than the maximum digital count of 255, and at least one modulated display datum has the digital count less than that of the corresponding display datum; and a step 230 of outputting the modulated display datum.

In detail, when the modulating unit 120 receives the display datum from the input unit 110, the modulating unit 120 reduces the digital count of the received display datum to generate the modulated display datum according to a linear modulating method. Preferably, the linear modulating method is configured for modulating the received display datum according to a following formula of Output=Input−Offset*(255−Input)/255. Wherein, Output is a modulated result modulated by the linear modulating method, Input is the digital count of the received display datum, and Offset is a predetermined value designated by users (such as a predetermined digital count of 8 in the exemplary embodiment). After obtaining the modulated result Output, it must verify whether the modulated result is a logical value. Generally, the digital count of the display datum is in digital counts of 0-255. Thus when the modulated result Output is smaller than 0, the modulating unit 120 regards the minimum digital count 0 as the digital count of the modulated display datum. On the contrary, when the modulated result Output is not smaller than 0, the modulated unit 120 directly regards the modulated result Output as the digital count of the modulated display datum and outputs it.

That is, in the above method of the present invention, when the digital count of the received display datum is the maximum digital count of 255, it will keep the maximum digital count of 255 as the digital count of the modulated display datum. Furthermore, if the digital count of the received display datum is nearer to the maximum digital count of 255, the digital count of the modulated display datum is nearer to the digital count of the received display datum. If the received display datum is nearer to the predetermined digital count of 8, a reducing degree between the digital counts of the modulated display datum and the received display datum is larger, and the reducing degree is nearer to the predetermined digital count of 8.

In summary, the flat display and the method for modulating the display datum of the present invention not only can enhance the display effect of the flat display in dark, but also can keep the maximum display datum in modulating, that is keep unchanging the maximum luminance. Therefore, it will not influence the display effect of the flat display in bright, and can enhance the contrast degree of the flat display.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for modulating display data of a flat display, comprising:
receiving a display datum with a digital count between a maximum digital count and a minimum digital count;
modulating the display datum to correspondingly generate a modulated display datum, wherein the modulated display datum has a digital count same as that of the corresponding display datum when the digital count of the corresponding display datum is the same as the maximum digital count, and the modulated display datum has the digital count no more than that of the corresponding display datum when the digital count of the corresponding display datum is less than the maximum digital count, wherein at least one modulated display datum has the digital count less than that of the corresponding display datum; and
outputting the modulated display datum.

2. The method according to claim 1, wherein the step of modulating the display datum comprises:
reducing the display datum according to a linear modulating method to generate a modulated result;
regarding a digital count of 0 as the digital count of the modulated display datum when the modulated result is smaller than 0; and
regarding the modulated result as the digital count of the modulated display datum when the modulated result is not smaller than 0.

3. The method according to claim 2, wherein the minimum digital count is the digital count of 0, and the maximum digital count is a digital count of 255.

4. The method according to claim 3, wherein the linear modulating method is modulating the display datum according to Output=Input+Offset*(255−Input)/255, Output is the modulated result, Input is the digital count of the display datum, and Offset is a predetermined value designated by a user.

5. A flat display, comprising:
an input unit configured for receiving a display datum with a digital count between a maximum digital count and a minimum digital count;
a modulating unit electrically coupled to the input unit for receiving the display datum from the input unit and modulating the display datum to correspondingly generate a modulated display datum, wherein the modulated display datum has a digital count same as that of the corresponding display datum when the digital count of the corresponding display datum is the same as the maximum digital count, and the modulated display datum has the digital count no more than that of the corresponding display datum when the digital count of the corresponding display datum is less than the maximum digital count, wherein at least one modulated display datum has the digital count less than that of the corresponding display datum; and
an output unit electrically coupled to the modulating unit for receiving the modulated display datum generated by the modulating unit, and outputting the modulated display datum.

6. The flat display according to claim 5, wherein the modulating unit reduces the display datum according to a linear modulating method to obtain a modulated result, regards a digital count of 0 as the digital count of the modulated display datum when the modulated result is smaller than 0, and regards the modulated result as the modulated display datum when the modulated result is not smaller than 0.

7. The flat display according to claim 6, wherein the minimum digital count is the digital count of 0, and the maximum digital count is a digital count of 255.

8. The flat display according to claim 7, wherein the modulating unit modulates the display datum according to Output=Input+Offset*(255−Input)/255, Output is the modulated result, Input is the digital count of the display datum, and Offset is a predetermined value designated by a user.
